(19) United States
(12) Patent Application Publication
(10) Pub. No.: US 2009/0017261 A1
(43) Pub. Date: Jan. 15, 2009

(54) CELLULAR CUSHIONING ARTICLE AND ROLL

(76) Inventors: Rupert B. HURLEY, JR., Greenville, SC (US); Charles Kannankeril, North Caldwell, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/172,763

(22) Filed: Jul. 14, 2008

Related U.S. Application Data
(60) Provisional application No. 60/949,666, filed on Jul. 13, 2007.
(60) Provisional application No. 60/974,159, filed on Sep. 21, 2007.

(51) Int. Cl. B32B 3/00

(52) U.S. Cl. 428/166

(57) ABSTRACT

A cellular cushioning article and roll is provided. The cellular cushioning article and roll may include a film that has a plurality of multi-size bubbles for cushioning. The bubbles may be arranged in a pattern such that any straight line, which is positioned between two bubbles and extends from one side of the film to another side of the film, crosses at least one other bubble of the film. The bubbles may also be arranged in a pattern wherein at least one of the relatively lower bubbles is positioned at least partially within an area defined by the perimeters of the relatively higher bubbles and two straight lines tangent to the perimeters of the two relatively higher bubbles and extending therebetween.

### CROSS-REFERENCE TO RELATED APPLICATIONS

This application claims the benefit of U.S. Provisional No. 60/949,666 filed on Jul. 13, 2007 and U.S. Provisional No. 60/974,159 filed on Sep. 21, 2007, both of which are incorporated herein by reference in their entirety.

### BACKGROUND

Cellular cushioning article has been used for several decades. Cellular cushioning articles are typically used for cushioning items that may be fragile or otherwise need protection. Cellular cushioning articles have included a film formed with pockets and adhered to a flat film, with the formed pockets being filled with air to define individual cells or bubbles. In addition, inflatable cellular cushioning articles have recently come into commercial use.

With cellular cushioning articles, increased bubble height is a desired feature for protecting items, such as for void fill. Bubble height is typically proportional to the diameter of the bubble such that the larger the diameter, the higher the bubble height. As the diameter of the bubbles gets larger, it becomes more difficult to conform the cellular cushioning article around objects because the large bubble size limits the wrapping radius. Therefore, increasing bubble height for void fill and the like comes at a cost of losing some degree of wrappability of the cellular cushioning article. Also, the film or web used to form the cellular cushioning article may experience increased levels of shrinkage, i.e., contraction, because of larger bubble heights and diameters. With greater levels of film shrinkage, more film is necessary to produce the cellular cushioning article. As such, the cost for the cellular cushioning article increases. In order to enjoy the benefits and reduce the drawbacks of higher bubble size, some users of cushioning have used two different sheets of cellular cushioning articles in the same package: a cellular cushioning article having higher bubbles for void fill and a cellular cushioning article having lower bubbles for wrapping around the object being packaged. However, the use of two different cellular cushioning articles effectively increases the material usage and size of packaging, and is more complex as different cellular cushioning articles must be stocked and thereafter used in a particular manner.

Additionally, it is generally too time consuming for users to meticulously inspect how bubbles of cellular cushioning articles match up with the objects they wrap. Therefore, a user typically applies cellular cushioning article to an object without considering how the article is matching up with the object. As a consequence, the object may not be properly protected because vulnerable portions of the object may not be touching or near bubbles.

Accordingly, cellular cushioning article with improved usability, cushioning characteristics, and the ability to conform around an object and limit web shrinkage is needed.

### SUMMARY

In one embodiment, a cellular cushioning article includes at least one film defining a plurality of bubbles including at least relatively lower bubbles and relatively higher bubbles for cushioning. The bubbles may be arranged in a repeating pattern such that any straight line that extends from one side of the film to another side of the film and is positioned between two bubbles crosses at least one other bubble of the film. The plurality of bubbles arranged in a pattern may include at least one cluster configuration with multiple bubbles closely packed and at least one higher bubble having a greater height than the bubbles of the cluster configuration. A cluster configuration may have the same width as at least one higher bubble. Also, a cluster configuration may include seven bubbles closely packed together.

In another embodiment, a roll of cellular cushioning article includes at least one continuous film defining a plurality of bubbles including at least relatively lower bubbles and relatively higher bubbles for cushioning and being wound into a roll defining a plurality of wound layers. The bubbles may be arranged in a repeating pattern that includes at least one cluster configuration of relatively lower bubbles closely packed together and at least one relatively higher bubble having a greater height than the bubbles of the cluster configuration. At least some of the relatively higher bubbles of one wound layer may at least partially nest with one or more cluster configurations on an adjoining layer. The plurality of bubbles arranged in a pattern may include at least one cluster configuration with multiple bubbles closely packed and at least one higher bubble having a greater height than the bubbles of the cluster configuration. The plurality of bubbles arranged in a pattern may include at least one row of cluster configurations that extends across the film and at least one row of higher bubbles that extends across the film and is adjacent the row of cluster configurations.

In another embodiment, a cellular cushioning article includes at least one film defining two relatively higher round bubbles positioned adjacent to each other and each defining a perimeter and one or more relatively lower bubbles. At least one of the relatively lower bubbles may be positioned at least partially within an area defined by the perimeters of the relatively higher bubbles and two straight lines tangent to the perimeters of the two relatively higher bubbles and extending therebetween. One of the straight lines may cross one or more of the relatively lower bubbles.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A is a top view of a cellular cushioning article according to one embodiment of the invention;

FIG. 1B is an enlarged view of a portion of the cellular cushioning article in FIG. 1A;

FIG. 1C is an enlarged view of a portion of the cellular cushioning article in FIG. 1A;

FIGS. 2A-B are top views of cellular cushioning article with different bubble arrangements;

FIG. 3 is a lay-flat view of a cellular cushioning article;

FIG. 4 is an enlarged cross-sectional schematic view of a multilayer film for use in a cellular cushioning article;

FIG. 5 is a somewhat schematic side elevational view, partially in section, of an embodiment of the method of the invention;

FIG. 6 is an enlarged, fragmentary sectional view of the lower medial portion of FIG. 5.

FIG. 7 is a side view of a nested cellular cushioning roll according to an embodiment of the invention; and

FIG. 8 is a perspective view of cellular cushioning rolls that are wound up.

### DETAILED DESCRIPTION

The present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Generally, the present invention includes a cellular cushioning article or roll including a film with multi-size bubbles having bubbles with relatively lower heights (“lower bubbles”) and bubbles having heights higher than the heights of the lower bubbles (“higher bubbles”). The higher bubbles provide a desired bubble height and void-fill capability while the lower bubbles enhance the ability to wrap the cellular cushioning article or roll around an item, including reducing the wrapping radius of the article or roll. The higher bubbles typically provide for better cushioning volume, while the lower bubbles also increase the bubble density per unit area, which can provide for more complete cushioning so that items having small dimensions or features, such as a corner of a product, will be more likely to be directly cushioned by a bubble. The lower bubbles are generally stronger due to greater film thickness, which may be due to less stretching during thermoforming. Also, the lower bubbles may provide greater creep resistance since the bubble film is stretched less during thermoforming. In effect, the lower bubbles may provide a dual stage creep resistance. As the higher bubbles are deflected under load, and slowly lose air, the lower bubbles may take over and provide further creep resistance. The cellular cushioning article or roll with higher and lower bubbles provides dual properties, namely dunnage (higher bubbles) and product conformability (lower bubbles). The lower bubbles generally also provide secondary cushioning.

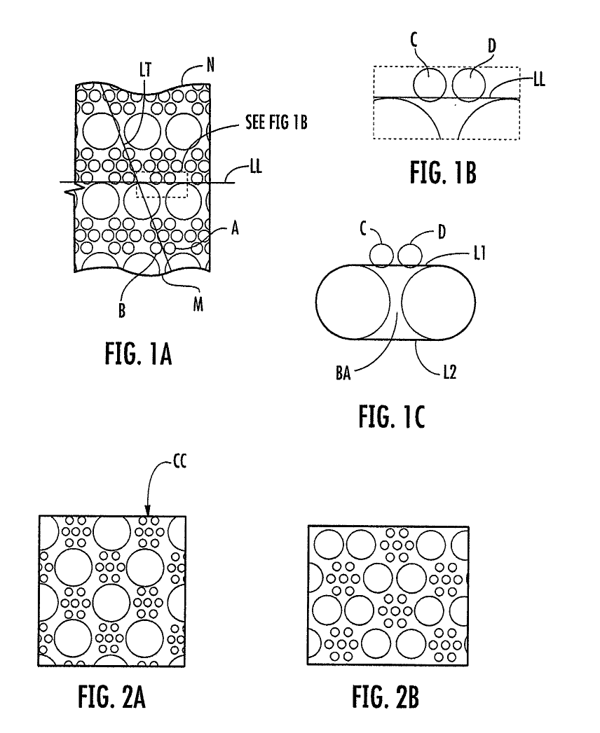

Unlike closely packed bubbles of the same diameter and height, bubbles of different size may be arranged in various configurations. In particular, bubbles may be arranged so that any straight line drawn across the cellular cushioning article or roll and between at least two bubbles touches or passes through at least one other bubble. In other words, a film may include a plurality of bubble sizes arranged in a pattern whereby any straight line going from one side of a cellular cushioning article or roll to another side of the article or roll and positioned between two bubbles touches or crosses at least one other bubble of the film. For example, in FIG. 1A, a cellular cushioning article with multi-size bubbles is shown. The bubbles in FIG. 1A are arranged so that a line drawn from any side of the article to another side of the article and between two bubbles touches or crosses at least one other bubble. In FIG. 1A, line LT is drawn from side M to side N of the article between bubbles A and B and crosses many bubbles along its path. Also, in FIG. 1A, line LL is drawn from one side of the article to another side and just above a row of higher bubbles. While line LL does not cross any higher bubbles, line LL does cross several lower bubbles because lower bubbles are positioned between the big bubbles. In particular, FIG. 1B shows an enlarged view of lower bubbles C,D positioned between higher bubbles with line LL passing through both lower bubbles C,D. FIG. 1C shows lower bubbles C,D positioned at least partially within an area BA defined by the perimeters of the higher bubbles and two straight lines L1, L2 therebetween. By placing lower bubbles C,D between the higher bubbles as shown in FIG. 1C, the cellular cushioning article provides an improved cushioning device by ensuring that edges of an object, such as represented by line LL, at least cross lower bubbles. As such, users can generally wrap items without checking to see if the edges of the item are properly cushioned by bubbles. Of course, this can save the user time and money, particularly if the user has numerous items to wrap and/or large items. In addition, the closely-packed configuration of lower bubbles C, D helps improve overall bubble density by taking advantage of the otherwise uncushioned land space between the higher bubbles.

The bubbles may be arranged so that lower bubbles are in a cluster configuration between higher bubbles. The cluster configuration may include seven lower bubbles or other quantity of lower bubbles occupying the space of one higher bubble. As an example, FIG. 2A shows a cluster configuration CC. Of course, a cluster configuration may include other numbers of bubbles or other arrangements of bubbles. As shown in FIG. 2A, a cellular cushioning article may have a row extending between sides of the article with alternating cluster configurations and higher bubbles. FIG. 2B shows another arrangement where a cellular cushioning article includes a row with two consecutive higher bubbles followed by a single cluster configuration. Various other combinations of lower and higher bubbles may be created in the cellular cushioning article or roll. Bubbles with the same diameter and different heights, bubbles with different diameters and different heights, and/or different diameters and the same height may be provided. Also, various shapes of bubbles may be provided. For instance, the bubbles may have a footprint that is conical, square, rectangular, or some other shape. The bubbles may be half spheres, cylinders with domed roofs, cylinders with flat roofs, or the like. In addition, a cellular cushioning article or roll may include several different bubble shapes, as well as different bubble sizes.

The cellular cushioning article may be formed using known film constructions and methods. For example, U.S. Pat. Nos. 3,294,387; 5,665,456; 6,800,162; and 6,982,113, are incorporated herein by reference in their entirety.

Film Constructions and Methods

Cellular cushioning articles and rolls may include various types of films. Along with methods of forming bubbles, a few examples of films typically used to create inflatable bubbles and non-inflatable bubbles are described below. The cellular cushioning article or roll described throughout this disclosure may include inflatable bubbles, non-inflatable bubbles, and/or any other type of bubbles for cushioning. Of course, other types of films and other methods of forming bubbles may be used.

As used herein, the term “film” is used in a generic sense to include plastic web, regardless of whether it is film or sheet. Typically, films may have a thickness of 0.25 mm or less.

As used herein, the term “seal” refers to any seal of a first region of a film surface to a second region of a film surface, wherein the seal is formed by heating the regions to at least their respective seal initiation temperatures. The sealing can be performed by any one or more of a wide variety of manners. The term “seal”, as used herein, is also inclusive of a film adhered to itself with an adhesive, or films adhered to one another with an adhesive.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces are adhered to another layer of the film.

As used herein, the term “adhered” is inclusive of films which are directly adhered to one another using a heat seal or other means, as well as films which are adhered to one another using an adhesive which is between the two films.

As used herein, the term “laminated” shall mean “firmly united or adhered thereto”. Accordingly, “laminated” shall not mean “readily dislodgeable or separable.”

As used herein, the term “creep” shall mean loss of bubble height due to air loss under load.

Inflatable Bubbles

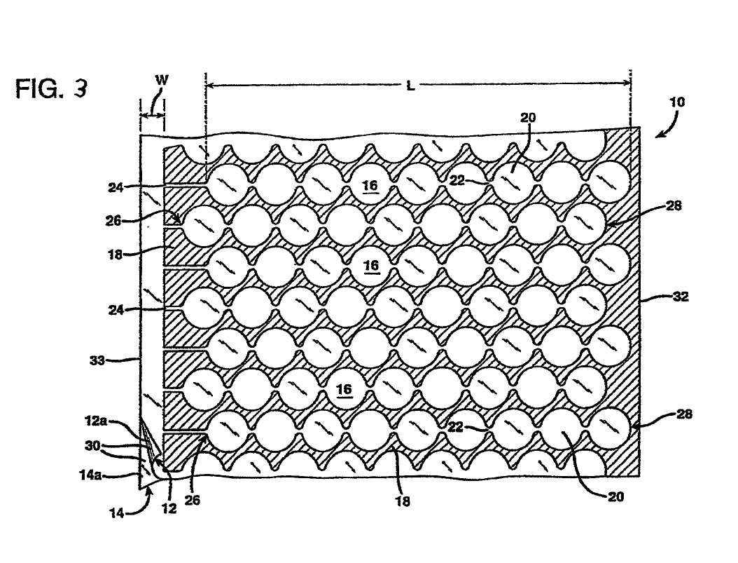

A cellular cushioning article or roll may include inflatable bubbles formed from various types of film. Referring to FIG. 3, there is shown an inflatable cellular cushioning article 10, including two films 12 and 14 having respective inner surfaces 12a and 14a sealed to each other in a pattern defining a series of inflatable chambers 16 of predetermined length “L.” Length L may be substantially the same for each of the chambers 16, with adjacent chambers being off-set from one another as shown in order to arrange the chambers in close proximity to one another. Films 12 and 14 are sealed to each other in a pattern of seals 18, leaving unsealed areas which define the inflatable chambers 16 such that each of the chambers has at least one change in width over their length L. That is, seals 18 may be patterned to provide in each chamber 16 a series of sections 20 of relatively large width in fluid communication with the other cells of the chamber via relatively narrow passageways 22. When inflated, sections 20 may provide essentially spherical bubbles in inflatable cellular cushioning article 10 by symmetrical outward movement of those sections of films 12 and 14 comprising the walls of sections 20. This will generally occur when films 12 and 14 are identical in thickness, flexibility, and elasticity. Films 12 and 14 may, however, be of different thickness, flexibility or elasticity such that inflation will result in different displacement of films 12 and 14, thereby providing hemispherical or asymmetrical bubbles.

Seals 18 are also patterned to provide inflation ports 24, which are located at proximal end 26 of each of the inflatable chambers 16 in order to provide access to each chamber so that the chambers may be inflated. Opposite to proximal end 26 of each chamber is closed distal end 28. As shown, seals 18 at proximal end 26 are intermittent, with inflation ports 24 being formed therebetween. Inflation ports 24 are narrower in width than inflatable sections 20 of relatively large width, in order to minimize the size of the seal required to close off each chamber 16 after inflation thereof.

Inflatable cellular cushioning article 10 further includes a pair of longitudinal flanges 30, which are formed by a portion of each of films 12 and 14 that extend beyond inflation ports 24 and intermittent seals 18. In the embodiment shown in FIG. 3, flanges 30 extend out equally beyond ports 24 and seals 18. The flanges accordingly have equivalent widths, shown as width “W.” Flanges 30, in conjunction with ports 24 and seals 18, constitute an open inflation zone in inflatable cellular cushioning article 10 that is configured to provide rapid and reliable inflation of chambers 16. The inner surfaces of flanges 30 can be brought into close slidable contact with outwardly facing surfaces of an appropriately configured nozzle or other inflation means so as to provide a partially closed inflation zone which promotes efficient and reliable sequential inflation of chambers 16 without restricting the movement of the web or inflation nozzle that is required to effect this sequential inflation. Flanges 30 may be at least ¼ inch. The flanges may have different widths, but they typically are equal in width, as shown in FIG. 3.

The seal pattern of seals 18 may provide uninflatable planar regions between chambers 16. These planar regions serve as flexible junctions that may be used to bend or conform the inflated cellular cushioning article about an item in order to provide optimal cushioning protection. As described with respect to FIG. 1C, lower bubble chambers may be placed in the planar regions between higher bubble chambers. By positioning lower bubble chambers in this manner, the cellular cushioning article increases bubble height while still retaining some planar regions due to the relatively small footprint of the lower bubbles. The lower bubbles could be connected by narrow passageways 22 extending from the higher bubbles, or could be connected to each other by narrow passageways 22 and separate inflation ports 24, or a combination of both. In another embodiment, the seal pattern may include relatively narrow seals that do not provide planar regions. For example, a cellular cushioning article with higher bubbles closely packed together would have limited planar regions. These seals serve as the common boundary between adjacent chambers.

The seals 18 may be heat seals between the inner surfaces of the films 12 and 14. Alternatively, films 12 and 14 may be adhesively bonded to each other. “Heat seal” should be understood, however, to include the formation of seals 18 by adhesion of films 12 and 14 as well as by heat sealing. Multilayer films 12 and 14 include a thermoplastic heat sealable polymer on their inner surface such that, after superposition of films 12 and 14, inflatable cellular cushioning article 10 can be formed by passing the superposed sheets over a sealing roller having heated raised land areas that correspond in shape to the desired pattern of seals 18. The sealing roller applies heat and forms seals 18 between films 12 and 14 in the desired pattern, and thereby also forms chambers 16 with a desired shape. The sealing pattern on the sealing roller also provides intermittent seals at proximal end 26, thus forming inflation ports 24 and also effectively resulting in the formation of flanges 30.

The heat sealability of films 12 and 14 is provided by providing films 12 and 14 as multilayer films, each contacting the other with an outer film layer having a heat sealable polymer. In this manner, inflation ports 24 may be closed by heat sealing after inflation of a corresponding chamber.

In FIG. 3, films 12 and 14 are initially separate films that are brought into superposition and sealed, or a single flat film may be folded onto itself with the heat sealable surface facing inward. The longitudinal edge opposite from flanges 30, shown as edge 32 in FIG. 3, is closed. Closed edge 32 may be formed in the cellular cushioning article as a result of folding a single sheet to form sheets 12 and 14, whereby the fold constitutes edge 32, or by sealing separate films 12 and 14 in the vicinity of the longitudinal edge as part of the pattern of seals 18. Although this edge is shown as closed in FIG. 3, in other embodiments of the cellular cushioning article of this invention this edge may be open and include a pair of flanges similar to flanges 30 to provide a second open inflation zone for inflating a second series of inflatable chambers or for inflation of the chambers from both ends. Optionally, the unsealed portion could further include a passageway in the machine direction which serves as a manifold that connects each of the passageways along an edge of the cellular cushioning article. This can permit faster inflation of the cellular cushioning article.

The films used to make the inflatable cellular cushioning article of the present invention can be multilayer films, such as those having a seal layer, a gas barrier layer, and a tie layer between the seal layer and the gas barrier layer. The seal layers can comprise any heat sealable polymer, including polyolefin, polyamide, polyester, and polyvinyl chloride, and ionomer resin. The seal layers may contain a polymer having a major DSC peak of less than 105° C., or an ethylene/vinyl acetate copolymer having a melt point below 80° C. The polymers for use in the seal layers may include olefin homopolymers and copolymers, particularly ethylene/alpha-olefin copolymer, particularly homogeneous ethylene/alpha-olefin copolymer, linear homogeneous ethylene/alpha-olefin copolymer, homogeneous ethylene/alpha-olefin copolymer having long chain branching, and ionomer resin. Sealant polymers may include homogeneous ethylene/alpha-olefin copolymer such as a long chain branched homogeneous ethylene/alpha-olefin copolymer, e.g., AFFINITY® substantially linear homogeneous ethylene/alpha-olefin copolymer manufactured by The Dow Chemical Company, or EXACT® linear homogeneous product manufactured by the Exxon Chemical Company. Ethylene/hexene and ethylene/octene copolymers are typically used.

Although the inflatable cellular cushioning article can be made by sealing two outer film layers to one another, if the film cross-section is symmetrical with respect to layer composition, both outer layers are herein referred to as “seal layers”, even though only one of the layers is not heat sealed to the other film making up the inflatable cellular cushioning article. Because the seal layers make up the majority of the overall film weight, the seal layers are present for more purposes than just sealing. The seal layers may provide much of the strength, bulk, abuse, abrasion, and impact strength properties for the inflatable cellular cushioning article. The cross section of the multilayer film is generally symmetrical with respect to layer arrangement, layer thickness, and layer composition.

The gas barrier layer provides the multilayer film with the property of being relatively impervious to atmospheric gases. This provides the inflated cellular cushioning article with a longer life, as the gas barrier layer allows the inflated cellular cushioning article to retain gas in the cells for a longer period of time. This is important because without a gas barrier layer, the cushioning article under load can exhibit substantial loss of fluid in four to seven days. Suitable resins for use in the gas barrier layer include hydrolyzed ethylene/vinyl acetate copolymer (designated by the abbreviations “EVOH” and “HEVA”, and also referred to as “ethylene/vinyl alcohol copolymer”, and “saponified ethylene/vinyl acetate copolymer”), polyvinylidene chloride (including vinylidene chloride/vinyl chloride copolymer “PVDC-VC”, and vinylidene chloride/methyl acrylate copolymer “PVDC-MA”), polyacrylonitrile, polyester (including polyalkylene carbonate), polyamide, etc., as known to those of skill in the art. A typical gas barrier layer is made from 100% CAPLON® B100WP polyamide 6 having a viscosity of Fav=100, obtained from Allied Chemical.

As used herein, the phrase “tie layer” refers to any internal layer having the primary purpose of adhering two layers to one another. A tie layer contains a polymer capable of covalent bonding to polar polymers such as polyamide and ethylene/vinyl alcohol copolymer. In the present invention, the tie layer serves to adhere the seal layer to the gas barrier layer. The tie layer can comprise any polymer having a polar group thereon (particularly a carbonyl group), or any other polymer which provides sufficient interlayer adhesion to adjacent layers which comprise polymers which do not adequately adhere to one another. Such polymers include olefin/unsaturated ester copolymer, olefin/unsaturated acid copolymer, and anhydride modified olefin polymers and copolymers, e.g., in which the anhydride is grafted onto the olefin polymer or copolymer. More particularly, polymers for use in tie layers include anhydride modified polyolefin, anhydride modified ethylene/alpha-olefin copolymer, ethylene/vinyl acetate copolymer, ethylene/butylacrylate copolymer, ethylene/methyl methacrylate copolymer, ethylene/acrylic acid copolymer, ethylene/methacrylic acid copolymer, and polyurethane.

Typical polymers for use in the tie layer include olefin polymers which are modified (e.g., grafted) with one or more monomers such as acrylic acid, methacrylic acid, fumaric acid, maleic acid, maleic anhydride, 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, maleopimaric acid, tetrahydrophthalic anhydride, x-methylbicyclo(2.2.1)hept-5-ene-2,3-dicarboxylic acid anhydride, x-methylnorborn-5-ene-2,3-dicarboxylic acid anhydride, norborn-5-ene-2,3-dicarboxylic acid anhydride, Nadic anhydride, methyl Nadic anhydride, Himic anhydride, methyl Himic anhydride and other fused ring monomers, as known to those of skill in the art.

If desired or necessary, various additives are also included with the films. For example, additives comprise pigments, colorants, fillers, antioxidants, flame retardants, anti-bacterial agents, anti-static agents, stabilizers, fragrances, odor masking agents, anti-blocking agents, slip agents, and the like. Thus, the present invention encompasses employing suitable film constituents.

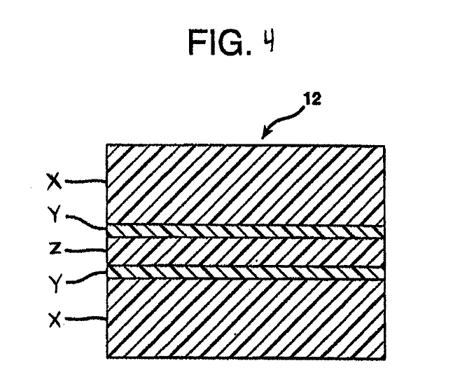

FIG. 4 illustrates a cross-sectional view of a multilayer film for use as films 12 and 14 in FIG. 3. Referring to FIG. 4, there is shown a cross-sectional view of film 12 having X/Y/Z/Y/X structure, film 12 having a total thickness of 1.6 mils.

The X layers may each be seal layers, and each make up 43 percent of the total thickness of the film. Each of the X layers may be a blend of 45% by weight HCX002 linear low density polyethylene having a density of 0.941 g/cc and a melt index of 4, obtained from Mobil, 45% by weight LF10218 low density polyethylene having a density of 0.918 g/cc and a melt index of 2, obtained from Nova, and 10% by weight SLX9103 metallocene-catalyzed ethylene/alpha-olefin copolymer, obtained from Exxon.

The Y layers may each be tie layers, and each make up 2% of the total thickness of film 12. Each of the Y layers may be tie layers made of 100% Plexar® PX3236 anhydride modified linear low density polyethylene copolymer, obtained from Qunatum Chemical. A pyrolysis analysis of Plexar® PX3236 resulted in a determination of the presence of anhydride at a level of 190 ppm, based on resin weight.

The Z layer may be a gas barrier layer, and make up 10% of the total thickness of film 12. The Z layer may be an O₂-barrier layer of 100% Caplon® B100WP polyamide 6 having a viscosity of Fav=100, obtained from Allied Chemical.

The films typically used to make the inflatable cellular cushioning article are generally blown or cast films. Blown films, also referred to as hot blown films, are extruded upwardly from an annular die, and are oriented in the lengthwise and transverse directions while still molten, by blowing the annular extrudate into a bubble (transverse orientation) and drawing on the bubble at a faster rate that the rate of extrusion (machine direction orientation). Another method of making the film for use in the present invention is a cast extrusion process in which molten polymer is extruded through a slot die, with the extrudate contacting a chilled roll shortly after extrusion. Both hot blown films and cast films can have a total free shrink (i.e., machine direction free shrink plus transverse free shrink) at 185° F. of less than 15 percent as measured by ASTM D 2732, more preferably, less than 10 percent.

The films from which the inflatable cellular cushioning article are typically made are thick enough to provide the inflatable article with adequate strength and durability, but thin enough to minimize the amount of resin necessary. If the maximum dimension of the cells is from 1 to 3 inches, each of the films may have a thickness of from 0.1 to 20 mils, more preferably, from 0.5 to 10 mils, more preferably from 0.5 to 4 mils, more preferably 0.5 to 3 mils, more preferably from 1 to 3 mils, more preferably, from 1 to 2 mils, and more preferably about 1.6 mils. As the films do not have an entirely uniform thickness, they can generally be described as having a unit weight of from 20 to 150 grams/square meter, more preferably 30 to 120 gms/square meter, more preferably 40 to 100 gms/square meter, more preferably 50 to 90 gms/square meter, more preferably 55 to 85 gms/square meter, and more preferably about 70 grams/square meter.

Non-Inflatable Bubbles

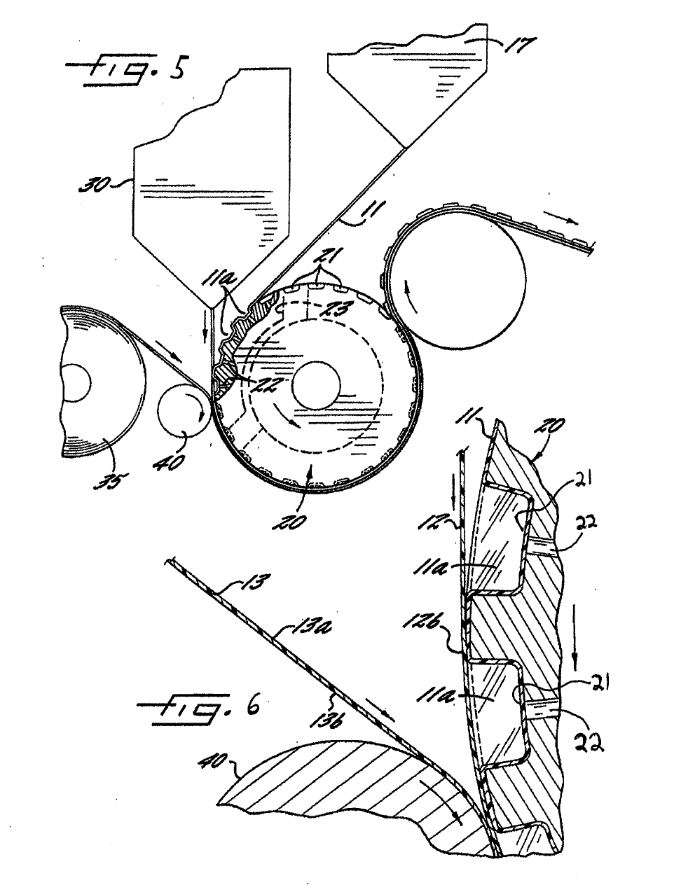

A cellular cushioning article or roll may include non-inflatable bubbles formed from various types of film. As described above in regards to inflatable bubbles, inflatable chambers are generally connected to an inflatable port by way of an inflatable chamber. Gas or the like are typically introduced into the inflatable chambers through the inflatable port and chamber to create gas-filled bubbles. On the other hand, non-inflatable bubbles are formed without inflatable chambers and ports. As described below, non-inflatable bubbles may encapsulate gas as the layers of film of the cellular cushioning article are combined. Simply, non-inflatable bubbles are formed without gas being introduced from chambers connecting the bubble to ports on the edges of the article. An embodiment of a method for making non-inflatable bubbles of the present invention is illustrated in FIGS. 5 and 6.

A first extruder 17 extrudes the first layer 11 of thermoplastic film into contact with the outer peripheral surface of an embossing roll 20 having cavities 21 in the outer surface thereof. The embossing roll 20 may include various configurations of cavities 21 on its surface. For example, as shown in FIGS. 5 and 6, the embossing roll 20 may include cavities 21 of varying depths in order to produce bubbles in film of varying heights. The cross-sections of FIGS. 5 and 6 are taken through the centers of the higher bubbles of the embodiment of the invention shown in FIG. 1. As such, although not visible in FIG. 5, the embossing roll may also have a cluster configuration of cavities including seven small diameter cavities near each other and next to a bigger diameter cavity.

Cavities 21 have openings 22 extending between the bottoms of the cavities 21 and a chamber 23 inside embossing roll 20. Chamber 23 has a vacuum drawn thereon in a manner not shown. The vacuum drawn on cavities 21 through openings 22 draws portions of the first layer 11 into the cavities 21 to form concave cavities 11a in the first layer 11.

A second extruder 30 extrudes a second layer 12 of thermoplastic film onto the surface of embossing roll 20 at a location spaced downstream of the location at which the first layer 11 contacts embossing roll 20 so that the second layer 12 is brought into superposed relation to the first layer 11 after the cavities 11a are formed therein. Because of the heated nature of the first and second layers 11 and 12, the second layer 12 will be almost instantly laminated to the first layer 11 over their contiguous surfaces entrapping air in the cavities 11a and forming the multiplicity of spaced apart air bubbles.

Another layer 13 of plastic film is fed from a roll 35 onto the embossing roll 20 and into superposed relation to the second layer 12 at a location sufficiently close to the extruder 30 such that layer 12 still retains sufficient residual heat to heat laminate the layer 13 to layer 12. To prevent premature shrinkage of the layer 13, a cooling roller 40 contacts the outside surface 13b of layer 13 immediately prior to the point of first contact of layer 13 with layer 12 and during lamination thereof. Cooling roller 40 has a coolant circulated therethrough in a manner not shown, but which is conventional to chill the outer periphery of the roll 40.

Of course, roll 20 may have other cavity configurations, such as lower and higher bubbles. Also, in FIG. 6, layer 13 may not be needed to form the cushioning article. Similarly, in FIG. 5, layer 13 and roll 35 may not be needed to form an article. Instead, layers 11 and 12 may form a cushioning article.

As the films do not have an entirely uniform thickness, they can generally be described as having a unit weight of from 20 to 70 grams/square meter, more preferably 25 to 65 gms/square meter, more preferably 30 to 60 gms/square meter, more preferably 30 to 50 gms/square meter, more preferably 30 to 45 gms/square meter, and more preferably about 38 grams/square meter.

Drop Tests

Drop tests of cellular cushioning articles were conducted by placing two layers of cellular cushioning articles under an object with a probe to measure the shock felt by the object in ‘G’ numbers, which represents the net effect of its acceleration. The probes measured the shock caused by testing blocks that were dropped on the cellular cushioning articles. Each block included a flat planar surface adapted to impact the articles in a generally horizontal manner. Also, the blocks contained enough mass to produce the desired load levels (0.05 psi and 0.11 psi) on the cellular cushioning articles during the drop test. For the test, two cellular cushioning article samples with multi-size bubbles were used (higher bubbles having a height of 0.5 inch and a diameter of 1.25 inches and lower bubbles having a height of 3/16 inch and a diameter of ⅜ inch, with a row of lower bubble clusters positioned between each row of higher bubbles, with each cluster of lower bubbles, including land area within the cluster, occupying the same overall footprint as the footprint of one higher bubble), namely a standard gauge product having unit weight of 85 g/12 sq ft and a light gauge product having unit weight of 65 g/12 sq ft. Both samples were tested against a control cellular cushioning article sample having only higher size bubbles and with a unit weight of 85 g/12 sq ft. Each of the samples was subjected to five drops at the two different load levels. The average ‘G’ values for drops 2-5 and the overall final average were determined and are shown in Chart 1 below.

As shown in Chart 1, the cellular cushioning article with multi-size bubbles produced better cushioning properties under higher load. All of the bubbles in the control samples (uniform higher bubble size) popped after the second drop, leaving no further cushioning protection. However, in the cellular cushioning article having multi-size bubbles sample, a fewer number of higher size bubbles popped compared to the control samples and none of the lower bubbles popped. It is believed that the lower bubbles absorbed some of the shock at the maximum deflection point of the higher bubbles and prevented them from popping. Furthermore, even if all of the higher bubbles had popped (which did not occur), it is believed the lower bubbles would still have provided additional protection with continued absorption of shock.

In the cellular cushioning article with multi-size bubbles sample, the load is supported initially by only half the number of the higher bubble compared to the control sample. Even with a fewer number of higher bubbles supporting the load, the shock felt by the object was not significantly different during the light load drop test. The slight increase in ‘G’ values for the low load multi-size bubble drop test may be explained by the fact that the higher bubbles may not deflect fully to make contact with the lower bubbles. In this case, the number of higher bubbles supporting the load is 50% less than the control. The fact that none of the higher bubbles popped during this low load test indicated that the cellular cushioning articles with multi-size bubbles still provided adequate protection.

In a heavy load drop test, a cellular cushioning article with multi-size bubbles made from 24% thinner film performed better than a heavy gauge control sample having only higher size bubbles.

| | | CHART 1 | | | | | | |
|---|---|---|---|---|---|---|---|---|
| | | ‘G’ values | | | | | | |
| | | | | | | | Drops | AVG |
| | Load | Drop Number | | | | | 2-5 | of all |
| Sample | (psi) | 1 | 2 | 3 | 4 | 5 | (AVG) | Drops |
| 85 g (large | 0.05 | 98 | 105 | 105 | 107 | 106 | 105 | 104 |
| bubble)(control) | (light | | | | | | | |
| | load) | | | | | | | |
| | 0.11 | 85 | 139 | 204 | not | not | 187 | 167 |
| | (heavy | | | (bubbles | tested | tested | | |
| | load) | | | popped) | | | | |
| 85 g (multi-size | 0.05 | 101 | 103 | 110 | 119 | 122 | 114 | 111 |
| bubble) | | | | | | | | |
| | 0.11 | 107 | 118 | 139 | 155 | 166 | 145 | 137 |
| 65 g (multi-size | 0.05 | 96 | 100 | 122 | 124 | 121 | 117 | 113 |
| bubble) (24% | | | | | | | | |
| lower gauge) | | | | | | | | |
| | 0.11 | 85 | 134 | 169 | 191 | 201 | 173 | 156 |
| | | | | | | (some | | |
| | | | | | | bubbles | | |
| | | | | | | popped) | | |

Multi-size bubbles on a cellular cushioning article can provide an initial cushioning of an object that is softer than that experienced with one size bubble articles. It provides a softer cushion because the higher bubbles are present in a lower density so that less pressure is required to obtain a deflection. After the initial impact with the higher bubbles, the lower bubbles are impacted and provide resistance along with the higher bubbles. In effect, the multi-size bubbles present a progressive shock absorption that results in a softer cushion. This softer cushioning provides improved impact resistance by lengthening deceleration times and, therefore, decreasing the peak ‘G’ values felt by the object. While approximately the same ‘G’ values were obtained at 0.05 load, a substantially less ‘G’ value was obtained under 0.11 load.

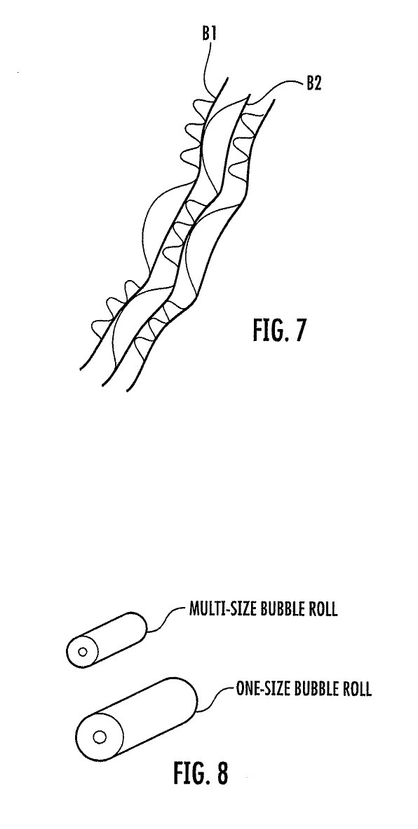

By having higher and lower bubbles on one cellular cushioning article, cost is reduced relative to the use of two different cellular cushioning articles in the same application. The higher and lower bubbles also nest easily during winding into a roll, reducing the bundle diameter. FIG. 7 shows an example of a cellular cushioning article nesting. The bubbles press into the backing layers of the article immediately on the inside, if the bubbles point inward, or immediately on the outside, if the bubbles point outward. In either case, the backing layers can accommodate the pressing of the bubbles where the big bubbles of one winding underlie (or overlie) the lower bubbles of the next winding. In FIG. 7, the bubbles point inward and touch backing layers B1 and B2. The higher bubbles in FIG. 7 are shown pressing against the backing layers B1 and B2 such that the lower bubbles overlying a higher bubble are pushed inward toward the backing layer inside of the lower bubbles. The lower bubbles effectively accommodate the higher bubble underlying them by moving inward to occupy the space between the lower bubbles and the backing layer immediately inside of them. In this way, the higher bubbles and lower bubbles nest. By nesting, the cellular cushioning article effectively reduces the bundle diameter, which is exemplified in FIG. 8. Therefore, the roll diameter and volume of a cellular cushioning article is reduced with different sized bubbles.

For example, a standard size bubble roll (e.g., cellular cushioning article with ½ inch high bubbles of the same diameter) may typically have a 42 inch roll diameter for 250 linear feet of material. In contrast, a cellular cushioning article with multi-size bubbles may have a roll diameter, for the same 250 linear feet of material, of only 34 inches. The cellular cushioning article with multi-size bubbles may contain rows of higher bubbles having a height of 0.5 inch and a diameter of 1.25 inches with rows of lower bubble clusters therebetween, each lower bubble having a height of 3/16 inch and a diameter of ⅜ inch, with each cluster of lower bubbles, including the land area within the cluster, occupying the same overall footprint as the footprint of one higher bubble. Of course, the bubbles may have various other dimensions. In this example, the bundle volume was reduced by 35 percent. The decrease in diameter, and the associated decrease in volume of the bundle, results in a significant reduction of shipping costs.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cellular cushioning article comprising:
at least one film defining a plurality of bubbles including at least relatively lower bubbles and relatively higher bubbles for cushioning, and
wherein the bubbles are arranged in a repeating pattern such that any straight line that extends from one side of the film to another side of the film and is positioned between two bubbles crosses at least one other bubble of the film.

2. The cellular cushioning article of claim 1, wherein the pattern comprises at least one cluster configuration of relatively lower bubbles closely packed together and at least one relatively higher bubble having a greater height than the bubbles of the cluster configuration.

3. The cellular cushioning article of claim 2, wherein at least one cluster configuration defines a width and has the same width as at least one relatively higher bubble.

4. The cellular cushioning article of claim 2, wherein a cluster configuration comprises seven relatively lower bubbles closely packed together.

5. The cellular cushioning article of claim 2, wherein the pattern comprises at least one row of cluster configurations that extends across the film and at least one row of relatively higher bubbles that extends across the film and is adjacent the row of cluster configurations.

6. The cellular cushioning article of claim 2, wherein the pattern comprises at least one row of alternating cluster configurations and relatively higher bubbles that extends across the film.

7. The cellular cushioning article of claim 2, wherein the pattern comprises at least one row defining a sequence of two consecutive cluster configurations followed by one relatively higher bubble and that extends across the film.

8. The cellular cushioning article of claim 2, wherein the height of the relatively lower bubbles of the cluster configuration are about 0.18 inch.

9. The cellular cushioning article of claim 2, wherein the height of the relatively higher bubble is about 0.5 inch.

10. A roll of cellular cushioning article comprising:
at least one continuous film defining a plurality of bubbles including at least relatively lower bubbles and relatively higher bubbles for cushioning and being wound into a roll defining a plurality of wound layers,
wherein the bubbles are arranged in a repeating pattern that comprises at least one cluster configuration of relatively lower bubbles closely packed together and at least one relatively higher bubble having a greater height than the bubbles of the cluster configuration, and further
wherein at least some of the relatively higher bubbles of one wound layer at least partially nest with one or more cluster configurations on an adjoining layer.

11. The roll of cellular cushioning article of claim 10, wherein at least one cluster configuration defines a width and has the same width as at least one relatively higher bubble.

12. The roll of cellular cushioning article of claim 10, wherein the pattern comprises at least one row of cluster configurations that extends across the film and at least one row of relatively higher bubbles that extends across the film and is adjacent the row of cluster configurations.

13. The roll of cellular cushioning article of claim 10, wherein the pattern comprises at least one row of alternating cluster configurations and relatively higher bubbles that extends across the film.

14. The roll of cellular cushioning article of claim 10, wherein the pattern comprises at least one row defining a sequence of two consecutive cluster configurations followed by one relatively higher bubble and that extends across the film.

15. A cellular cushioning article comprising:
at least one film defining two relatively higher round bubbles positioned adjacent to each other and each defining a perimeter, and
one or more relatively lower bubbles,
wherein at least one of the relatively lower bubbles is positioned at least partially within an area defined by the perimeters of the relatively higher bubbles and two straight lines tangent to the perimeters of the two relatively higher bubbles and extending therebetween.

16. The cellular cushioning article of claim 15, wherein the height of the relatively higher round bubbles is about 0.5 inch.

17. The cellular cushioning article of claim 15, wherein the height of the relatively lower bubbles is about 0.18 inch.

18. The cellular cushioning article of claim 15, wherein one of the straight lines crosses one of the relatively lower bubbles.

19. The cellular cushioning article of claim 15, wherein one of the straight lines crosses two of the relatively lower bubbles.
